(19) United States
(12) Patent Application Publication
(10) Pub. No.: US 2006/0248780 A1
(43) Pub. Date: Nov. 9, 2006

(54) Adjustable fishing float

(76) Inventors: Jim Elliott, Omaha, NE (US); Mike Hahn, Omaha, NE (US); Jim Seko, Omaha, NE (US); Martin Trout, Omaha, NE (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/409,769

(22) Filed: Apr. 24, 2006

Related U.S. Application Data
(60) Provisional application No. 60/676,527, filed on Apr. 29, 2005.

(51) Int. Cl. A01K 93/00

(52) U.S. Cl. 43/44.91; 43/44.9

(57) ABSTRACT

The present invention relates to an adjustable fishing float and a method of manufacturing an adjustable fishing float. The adjustable fishing float includes a float, a cap containing a collet, wherein the cap is rotatably connected to a base, and rotating the cap urges the collet against a neck region of the base, thus causing the collet to squeeze a fishing line passing through the fishing float.

This application claims priority to U.S. Provisional Patent Application No. 60/676,527 filed Apr. 29, 2005.

### FIELD OF THE INVENTION

The present invention relates to an adjustable fishing float and methods of using and manufacturing the adjustable fishing float.

### BACKGROUND OF THE INVENTION

Fishing floats or bobbers have been used to suspend a fishing bait or a fishing lure off the bottom of the lake, stream, pond, etc. Certain fishing techniques benefit from suspending the bait in the water column. Floats and bobbers generally include a buoyant structure, as well as a means to connect the buoyant structure to a fishing line.

Many prior art bobbers and floats are difficult to easily and accurately move on the fishing line to change the depths of the fishing bait or the fishing lure. Other problems with prior art bobbers and floats include a tendency to tangle the fishing line or to abrade, damage or kink the fishing line. Other problems with prior art bobbers include a tendency for the bobber to inadvertently release from the fishing line. These problems with the prior art bobbers often result in a loss of valuable fishing time or an equipment failure.

### SUMMARY OF THE INVENTION

The present invention relates to an adjustable fishing float and methods of manufacturing and using the adjustable fishing float. The adjustable fishing float comprises a float, a cap containing a collet, wherein the cap is rotatably connected to a base, and rotating the cap urges the collet against a neck region of the base, thus causing the collet to squeeze a fishing line passing through the fishing float.

The method of using the adjustable fishing float, comprises providing a float, a cap containing a collet, wherein the cap is rotatably connected to a base, and rotating the cap urges the collet against a neck region of the base, rotating the cap in a first direction to squeeze the collet against the neck region, and adjusting the depth of the fishing float by rotating the cap in a second direction thus loosening the collet.

The method of manufacturing the adjustable fishing float, comprises providing a float, a cap containing a collet, wherein the cap is rotatably connected to a base, and rotating the cap urges the collet against a neck region of the base, and inserting the base through an opening of the buoyant float.

### BRIEF DESCRIPTION OF THE DRAWINGS

FIGS. 1(a)-1(c) show views of the adjustable fishing float.

FIG. 2 shows a view of the cap, the collet, and the base.

FIGS. 3(a)-3(c) show views of the collet as it constricts.

FIGS. 4(a)-4(i) show views of the collet.

FIGS. 5(a)-5(c) show views of the cap.

FIGS. 6(a)-6(c) show views of the cap, the collet, and the base.

FIGS. 7(a)-7(c) show views of the base.

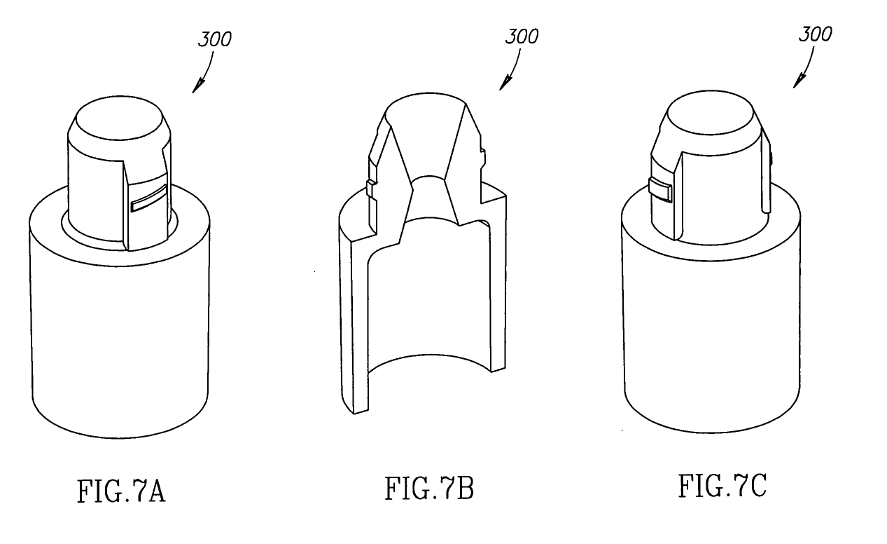

FIGS. 8(a)-8(d) show further views of the base.

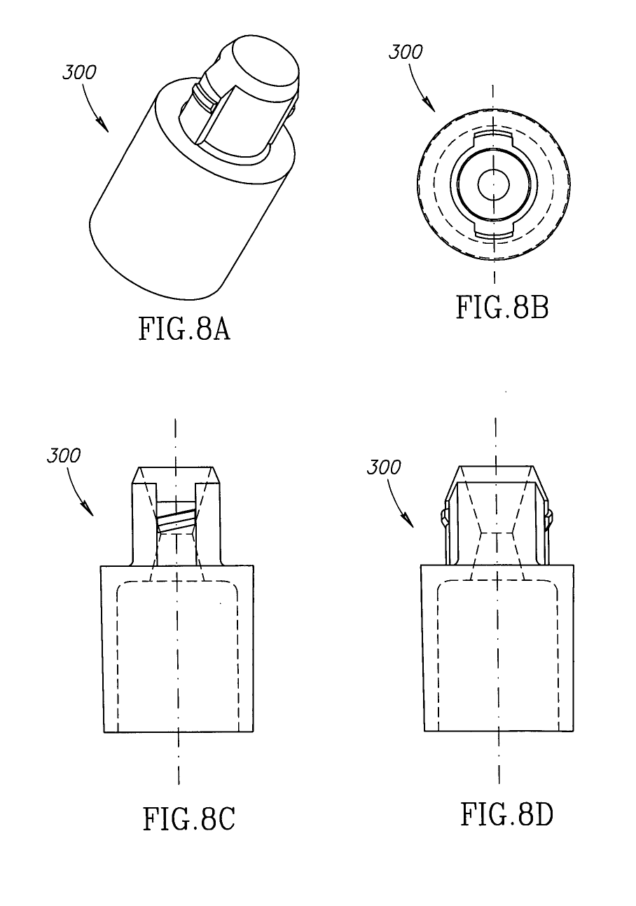

FIGS. 9(a)-9(h) show views of the collet.

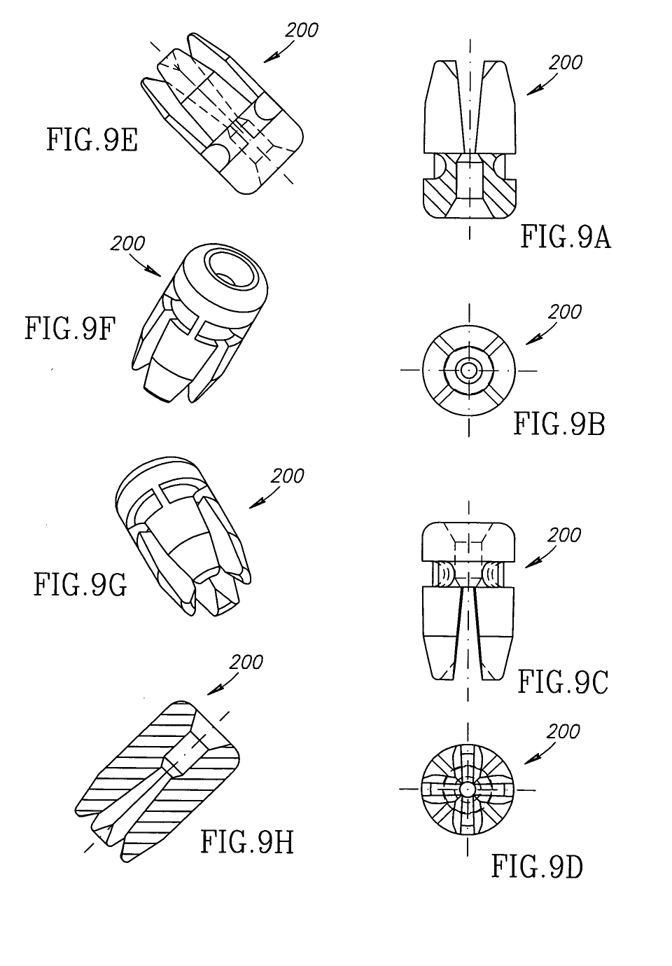

FIGS. 10(a)-10(f) show views of the cap.

FIGS. 11(a) and 11(b) show views of the base receiving the cap and the collet.

FIG. 12 shows a view of the float with the second embodiment of the base with the cap removed.

### DETAILED DESCRIPTION OF THE PREFERRED EMBODIMENT

The present invention relates to an adjustable fishing float and methods of using and manufacturing the adjustable fishing float. The adjustable fishing float comprises a cap that comprises a collet. The cap presses the collet against a base to squeeze the fishing line. The cap, the collet, and the base are used with a buoyant float to form the adjustable fishing float.

The collet forms a linear passage that narrows or widens to squeeze or release the fishing line. The collet is formed by a plurality of extensions that generally define the linear passage for the fishing line. The extensions are members that extend from a central region and bend relative to the central region to constrict or open the linear passage. The central region or head of the collet includes an opening for the fishing line to pass through.

By rotating the cap, which is threadably received by the base, the collet and its extensions are urged against the base as the cap screws onto the base and thus causes the extensions to bend and constrict the linear passage and ultimately squeeze the fishing line. By rotating the cap in the opposite direction, the collet is incrementally moved away from the base, thus opening the linear passage and releasing the line and allowing the line to easily move through the float.

In order to attach the adjustable fishing float to the fishing line, the line is threaded through the cap, through the collet, through the base, and through the bottom of the float. Next, the user rotates the cap urging the collet against the base, forcing the extensions of the collet against the base.

The adjustable fishing float of the present invention provides a smooth, non-abrasive surface that tightens against the fishing line. The adjustable fishing float does not abrade, damage, or kink the fishing line.

Moreover, to adjust the depth of the fishing float, the user merely rotates the cap thus loosening the extensions of the collet. Then the fishing float may be positioned up or down the fishing line, and the cap re-tightened, thus re-squeezing the extensions of the collet against the fishing line. The cap, the collet, and the base provide for the adjustability of the float.

Preferably, the cap contains the collet and the cap is located on the exterior of the adjustable fishing float or bobber. As the cap and the collet are on the exterior of the float, it is easy for the angler to manually manipulate, i.e., rotate, the cap to adjust the depth of the float or to put the float into a slip position. A portion of the base extends or protrudes from the main body of the buoyant float to threadably receive the cap and the collet. The portion of the base extending or protruding from the float is exterior to the float. The collet is also external to the main buoyancy structure of the float. The adjustable fishing float does not need to be removed from the line in order to adjust the depth of the float or to put the float into a slip position.

The adjustable fishing float of the present invention can be used as either a “slip” float or a “fixed” float. By leaving the collet in the released or open position, the float is allowed to slide or slip along the fishing line until it encounters a float stop. Float stops should be placed on the fishing line above the bait or lure at the depth which the bait or lure is to be suspended in the water column. Float stops provide a “brake” on the fishing line to set the depth of the float. Float stops may include a crimping device or structure, or other means that attach, bind, tie, etc. to the fishing line, but will not pass through the opening of the float. Most float stops readily available and known to one of ordinary skill in the art may be used with the adjustable fishing float. The float stop may be set at a depth of for example, six feet. The float is positioned on the line below the float stop. In the released or open position, the float will slide down the line toward the bait or lure. Since the float has slid toward the bait or lure, the float and bait or lure may now be easily cast during the fishing process. When the float and the bait or lure hit the water, the weight of the bait or lure pulls the line through the float until the float stop makes contact with the float, thus setting the depth of the bait or lure based on the float stop. Without the use of a float stop, the angler would have the unwieldy task of trying to cast a float positioned at a fixed position of, for example, six or more feet about the bait or lure. However, by using the float in a slip position, the angler may cast the float and bait with ease.

Many prior art floats and bobber require the user to tighten the bobber or float to the line to prevent the bobber from falling off of the line. The present invention does not require the float to be fixed in a non-slip manner to the line. While the float of the present invention can be fixed to the line, it is not required.

The present invention provides a float with a permanent nature. In certain embodiments, the fishing line is threaded through each component of the float of the present invention. Once the fishing line is inserted through the float of the present invention, the float and its components will not fall off of the line unless the components are physically destroyed or the line is cut. This prevents the fisherman from losing the float or its cap or other components. Many prior art bobber and floats have grooves, springs, or clips that often fail, resulting in the loss of the bobber or float or a component of the bobber or float.

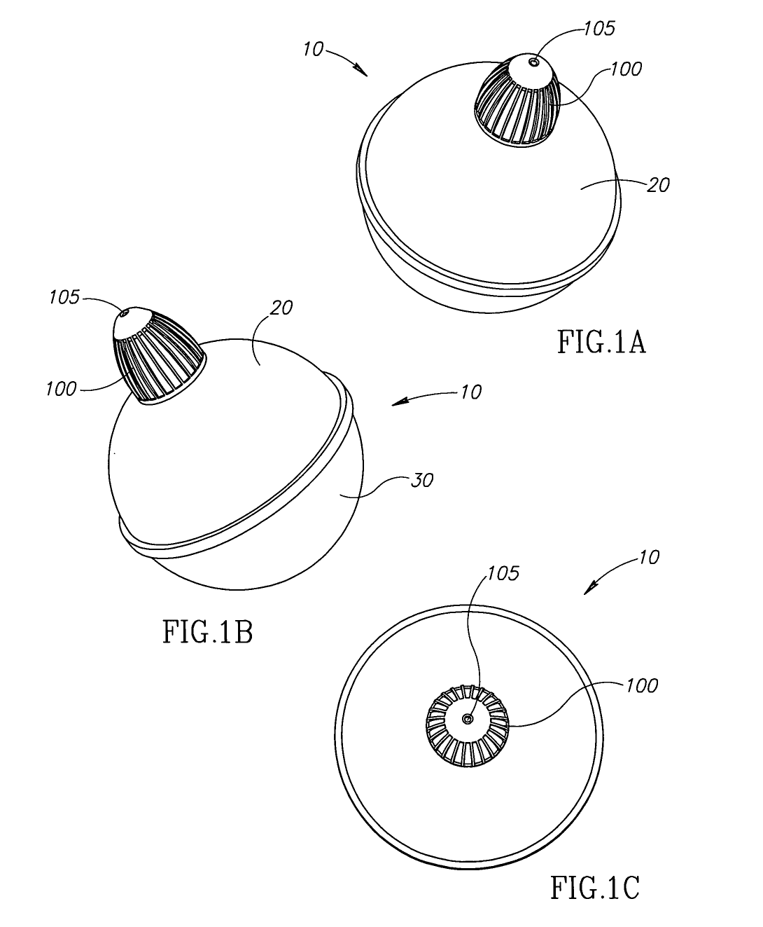

Certain embodiments of the present invention will now be discussed with respect to the figures. Turning now to FIG. 1, an adjustable fishing float 10 is shown. The adjustable fishing float 10 includes a float top 20 and a float bottom 30 that provide buoyancy for the fishing float 10. In FIG. 1, the cap 100 is shown on the exterior top-side of the float top 20. The cap 100 has an opening 105 to receive the fishing line. Although the adjustable fishing float 10 is shown as a generally spheroid structure, the present invention is not limited to any particular shape for its exterior float structure.

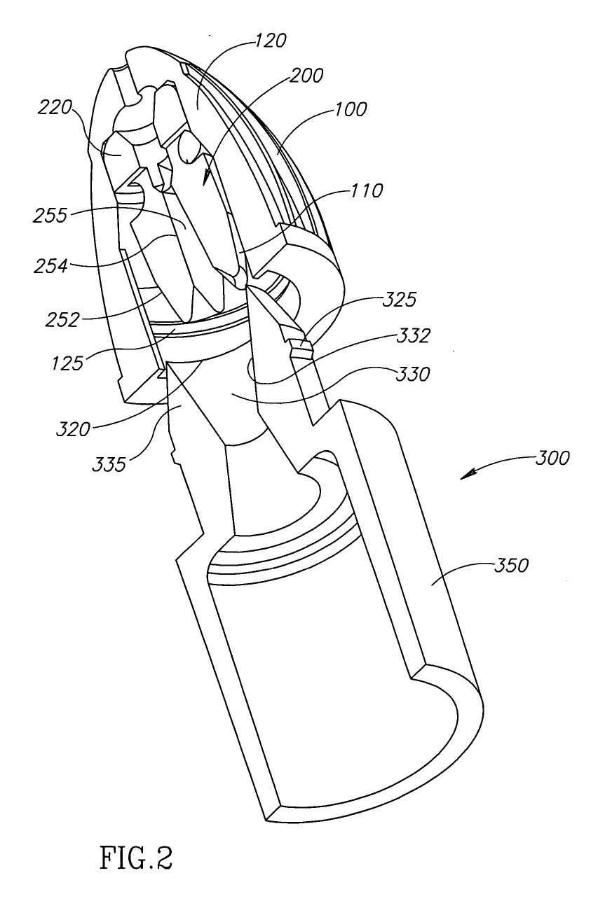

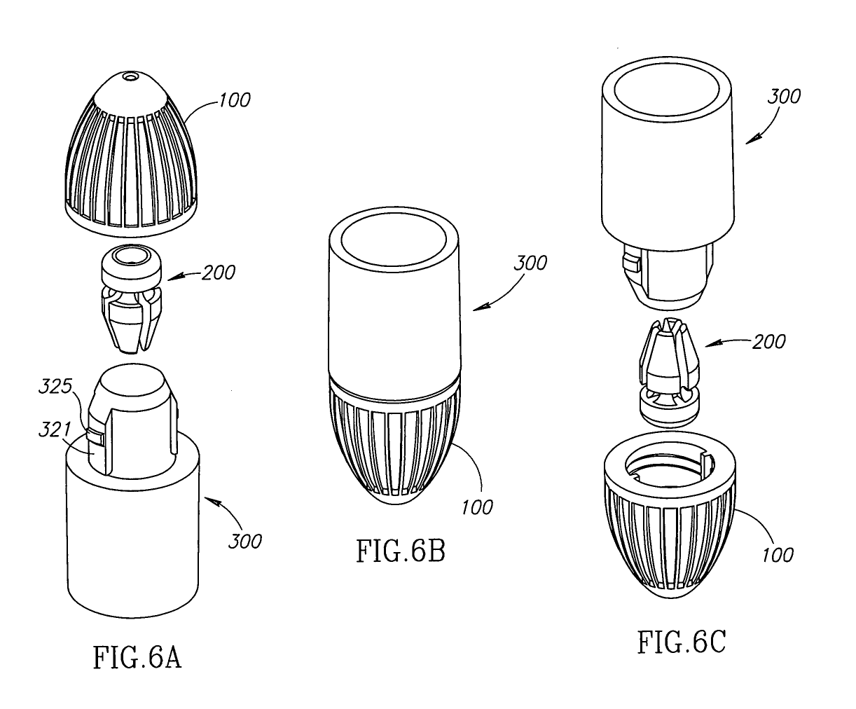

Turning now to FIG. 2, the cap 100 is shown containing a collet 200. The cap 100 receives a head 220 of the collet 200 in a secure engagement. The cap 100 is received by and rotatably tightens against a neck 320 of a base 300. The neck 320 includes threads 325 that operate in conjunction with threads 125 of the cap 100. As shown in FIG. 6, the neck 320 also includes positioner 321, which assists the cap 100 in aligning the threads 125 to the threads 325 of the neck.

The neck 320 defines a neck opening 330. The neck opening 330 decreases in diameter toward a body 350 of the base 300.

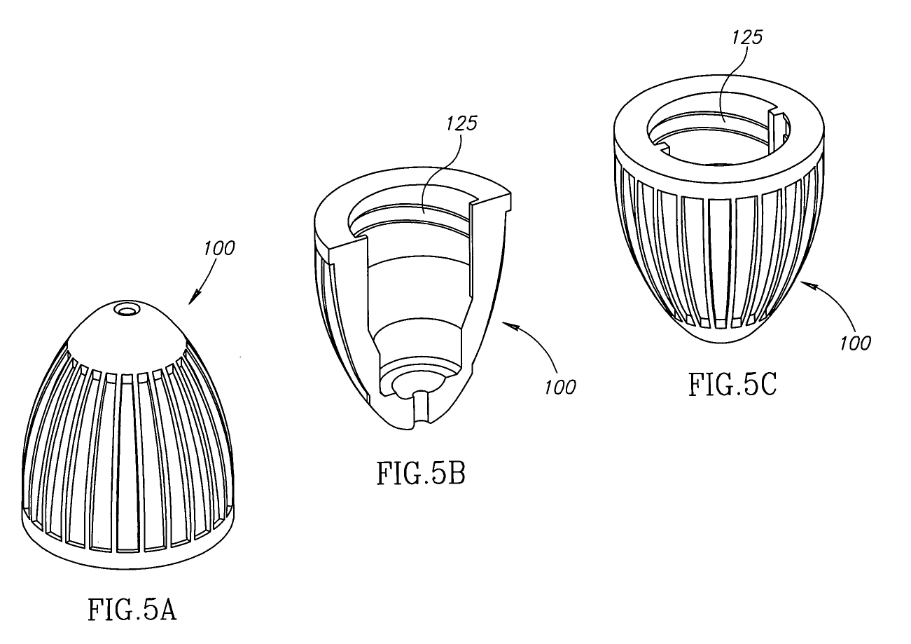

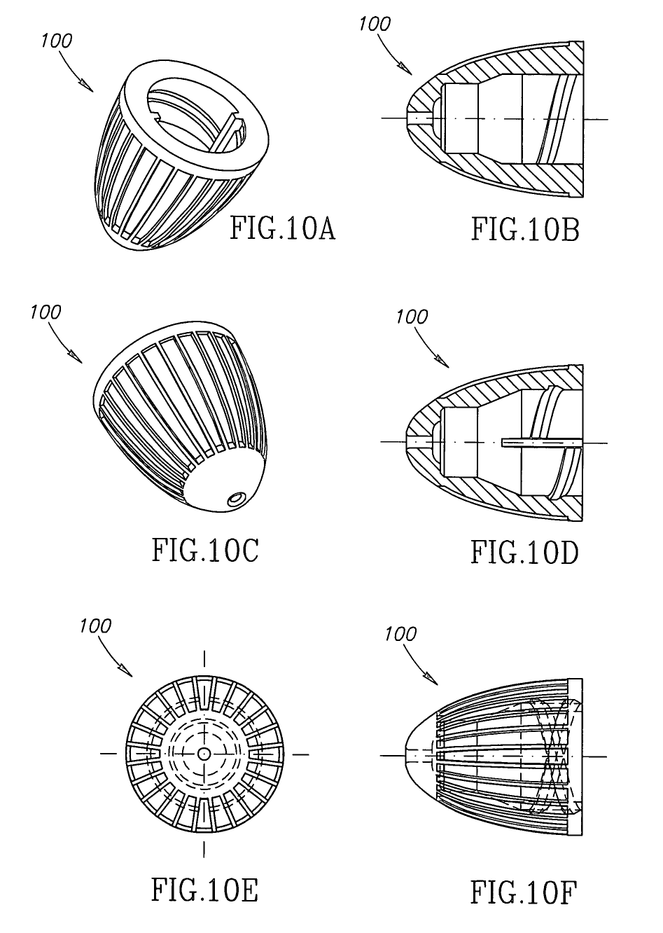

As shown in FIG. 2, the cap 100 must have sufficient volume to contain the collet 200 and neck walls 335. The collet 200 and walls 120 of the cap 100 define a space 110 in the cap 100 that ultimately receives the neck walls 335. The cap 100 is further shown in FIGS. 5 and 10.

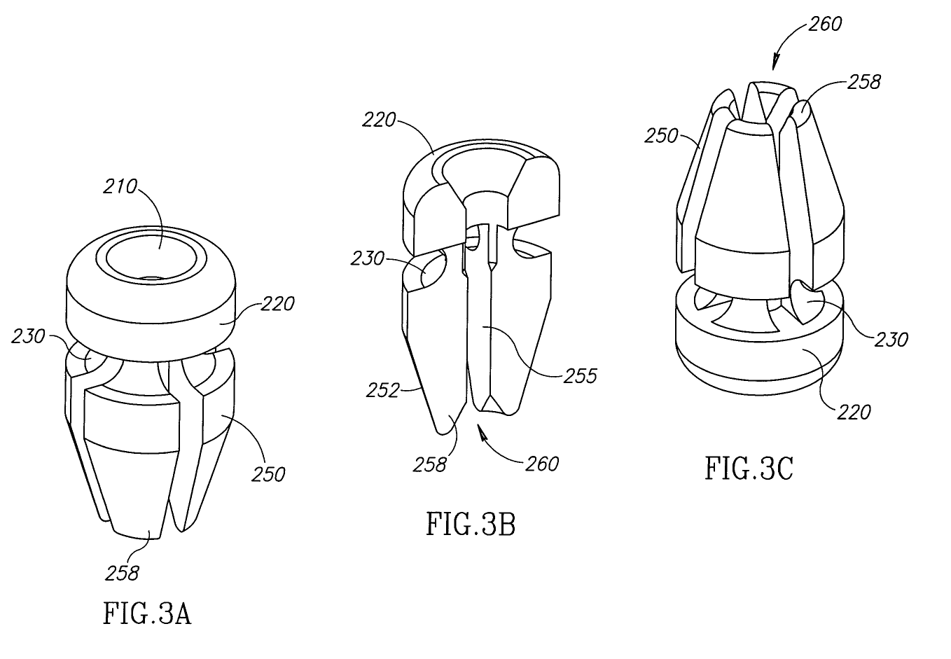

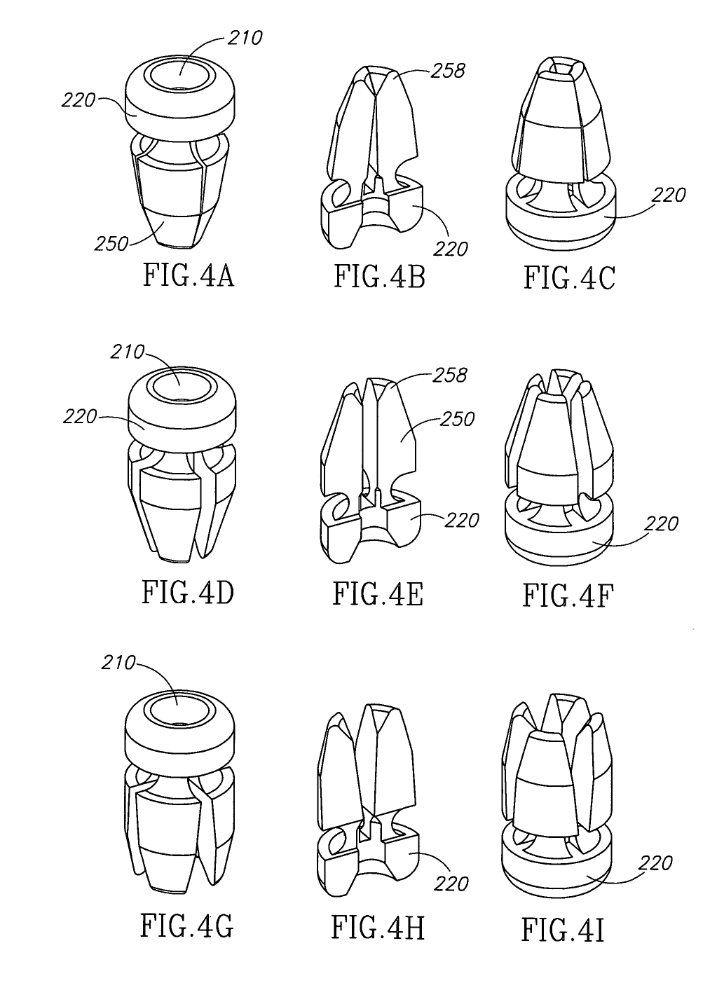

Various views of the collet 200 are shown in FIGS. 3 and 4. FIG. 4 shows the collet 200 opening and closing. The collet 200 includes a top opening 210 to receive the fishing line defined by the head 220 of the collet 200. The head 220 is received by the cap 100. The head 220 is shown as a generally round structure, although the head 220 may be in other shapes that support the extensions 250. The extensions 250 of the collet 200 extend from the head 220 of the collet 200. In this embodiment, four extensions 250 are shown. Of course, other embodiments may include more or less extensions 250. A bottom opening 260 of the collet 200 is formed by tips 258 of the extensions 250. The extensions 250 narrow in width toward their tips 258. This narrowing assists in forming the space 110 to receive the neck walls 330. The extensions 250 define a linear passage 255 for the fishing line that includes the bottom opening 260.

As the cap 100 is threadably tightened on the neck 320, a surface 332 of the neck walls 335 presses against outer extension surface 252. The neck walls 335 urging against outer extension surface 252 causes the extensions 250 to bend, thus centrally constricting the linear passage 255. An inner surface 254 of the extensions 250 are eventually squeezed against the fishing line to secure the adjustable fishing float 10 on the fishing line.

As discussed above, the space 110 is formed when the collet 200 is inserted into the cap 100. The space 110 is annular to the collet 200 and its extensions 250 and becomes filled by the neck walls 335 when the neck walls are inserted into the space 110 by threadably tightening the cap 100 to the base 350.

The outer extension surface 252 is complimentary in shape to the surface 332 of the neck walls 335. As the neck walls 335 press against outer extension surface 252, the outer extension surface 252 slides under the surface 332 of the neck walls 335. The outer extension surface 252 and the surface 332 of the neck walls 335 should have smooth surfaces that allow the outer extension surface 252 to slide under the neck walls 335.

The inner surface 254 of the extensions 250 provides a smoother, linear surface with surface area to squeeze upon the fishing line. The smooth, linear surface of the inner surface 254 does not nick or damage the fishing line.

The present invention includes the curved region 230 formed at the junction between the head 220 and the extensions 250. The curved region is shown in FIG. 3. The curved region 230 also includes a thinner portion of the extensions 250. The curved region 230 in conjunction with its relative thinness provide a section of the extensions 250 such that the extensions 250 can bend with respect to the head 220. The curved region 230 distributes the force of the bending action such that the extensions 250 do not break off from the head 220. As shown in FIG. 4, the curved region 230 opens pointing away from the linear passage 255, i.e., the convex surface of the curved region is closer to the linear passage 255 and the concave surface is farther from the linear passage 255. This orientation of the curved region provides for the extensions 250 to bend.

The adjustable fishing float of the present invention is preferably made of plastic materials. Different types of plastic may be used for the various components of the adjustable fishing float. Polystyrene is preferably used for the float top 20, float bottom 30, and the base 300. The collet 250 is preferably made from a thermal plastic elastomers, such as the particular elasotomer sold under the trademark Hytrel® from the Dupont® company. Hytrel® is a thermoplastic polyester elastomer well suited for forming the collet 250. The cap 100 is preferably made from a polypropylene.

During the manufacturing process, all the component parts may be formed by injection molding techniques. The component parts may be sonically welded, snap-fit, or solvent bonded together to form the float. In one embodiment, the float top 20 and the float bottom 30 are sonically welded together. The base 300 is inserted through an opening in the float top 20, and the base 300 is sonically welded to the float top 20 and the float bottom 30 with the neck 320 protruding from the float top 20. The collet 250 is press-fitted into the cap 100, and then cap 100 is pushed onto the neck 320 of the base 300. Other embodiments may use a one piece, solid body construction for the float structure. For example, a buoyant material, such as foam, may comprise the base 350. A passage may be formed in the foam to receive the base 350. Other embodiments may use a one-piece plastic construction, wherein the base 350 is integral, affixed, or inserted into the one-piece plastic construction.

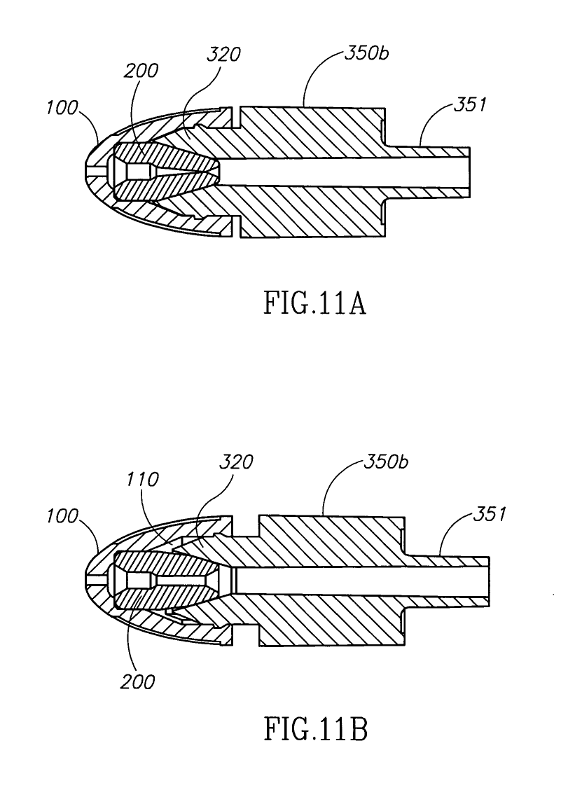

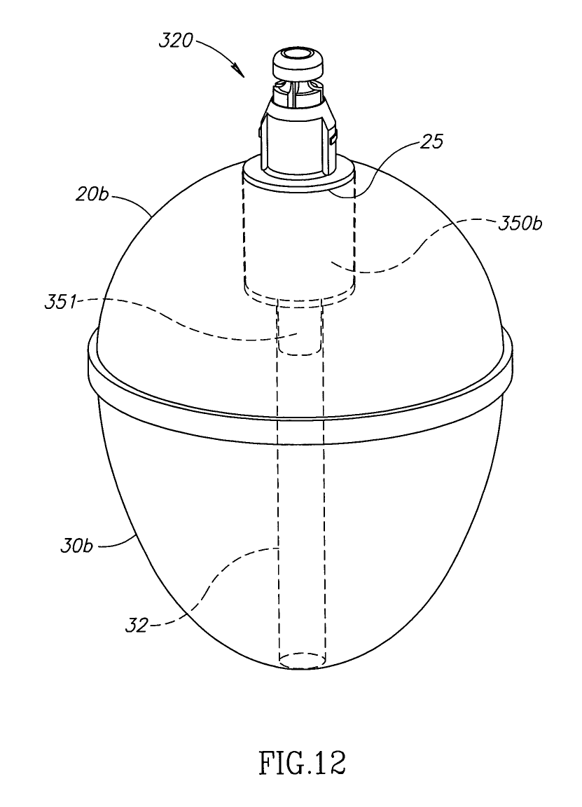

A second embodiment of the base, namely a base 350(b) is shown in FIGS. 11 and 12. The base 350(b) includes an extending portion 351 (opposite of the neck 320) that is received by the bottom half of the float 30(b). FIG. 11(a) shows the collet 250 in a closed position, while FIG. 11(b) shows the collet 250 in an open position. As shown in FIG. 12, a hollow stem 32 extends from the bottom of bottom half 30(b). The extending portion 351 is inserted into the hollow stem 32 to form the completed float. The hollow stem 32 receives the extending portion 351 in a sleeve-like engagement. The hollow stem 32 and the extending portion 351 may be sonically welded or solvent bonded together. The fishing line passes through the hollow stem 32.

FIG. 12 also shows the neck 320 extending or protruding from a float top opening 25 of a float top 20(b). The cap 100 is removed for convenience to show the collet 250 interacting with the neck 320. During normal use, the collet 250 is not separated from the cap 100. FIG. 12 also shows the collet 250 and the neck 320 external to the float top 20(b) and the float bottom 30(b). In this embodiment the collet 250 and the neck 320 are completely external to the float top 20(b) and the float bottom 30(b).

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

What is claimed is:

1. An adjustable fishing float comprising:
a float,
a cap containing a collet, wherein the cap is rotatably connected to a base, and rotating the cap urges the collet to constrict or squeeze on a fishing line threaded through the float, and,
the cap is exterior to the float.

2. The adjustable fishing float according to claim 1, wherein the cap rotatably connects to a neck region of the base that is exterior to the float.

3. The adjustable fishing float according to claim 1, wherein rotating the cap urges the collet against a neck region of the base.

4. The adjustable fishing float according to claim 3, wherein the neck region of the base extends from the float.

5. The adjustable fishing float according to claim 4, wherein the cap containing the collet has volume to receive the neck region of the base.

6. An adjustable fishing float according to claim 1, wherein the collet comprises a plurality of extensions.

7. The adjustable fishing float according to claim 6, wherein rotating the cap urges the collet against a neck region of the base, wherein the neck region includes neck walls, wherein an outer surface of the extensions are urged by the neck walls, causing the extensions to bend and centrally constricting a linear passage for the fishing line.

8. The adjustable fishing float according to claim 7, wherein the outer extension surface is complimentary in shape to the neck walls.

9. The adjustable fishing float according to claim 6, wherein rotating the cap urges the collet against a neck region of the base, wherein the neck region includes neck walls, wherein an outer surface of the extensions are urged by the neck walls, causing the extensions to bend and centrally constricting a linear passage for the fishing line, wherein the outer extension surface slides under the neck walls.

10. The adjustable fishing float according to claim 6, wherein an inner surface of the extensions provides a generally smooth, linear surface to squeeze upon the fishing line.

11. An adjustable fishing float according to claim 6, wherein the extensions extend from a head region of the collet.

12. An adjustable fishing float according to claim 6, wherein the extensions extend from the head region of the collet forming a junction having a curved surface.

13. An adjustable fishing float according to claim 12, wherein the convex surface of the curved region is closer to the linear passage than the concave surface of the curved region.

14. An adjustable fishing float according to claim 6, wherein the extensions extend from the head region of the collet forming a junction having a curved surface that allows the extensions to bend.

15. An adjustable fishing float according to claim 6, wherein the extensions extend from the head region of the collet at a junction having a thickness thinner than the remainder of the extensions.

16. The adjustable fishing float according to claim 1, wherein the adjustable fishing float comprises a float top and a float bottom, and a fishing line is threaded through the float top, the float bottom, the cap, and the collet.

17. The adjustable fishing float according to claim 1, wherein the fishing line is threaded through every component of the adjustable fishing float.

18. An adjustable fishing float according to claim 1, wherein the base includes an extending portion that is received by a hollow stem that extends from a bottom of the bottom half of the float, wherein the hollow stem receives the extending portion in a sleeve-like engagement.

19. An adjustable fishing float according to claim 1, wherein the collet is made from a thermoplastic polyester elastomer.

20. An adjustable fishing float according to claim 1, wherein the collet comprises a plurality of extensions, wherein the extensions are completely exterior to the float.

21. An adjustable fishing float comprising:
a float,
a cap containing a collet, wherein the cap is rotatably connected to a base, and rotating the cap urges the collet to constrict or squeeze on a fishing line threaded through the float, and
the collet comprises a plurality of extensions, wherein the extensions extend from the collet at a junction between the collet and the extensions, the junction having a curved surface.

22. A method of using an adjustable fishing float, comprising:
providing a float, a cap containing a collet, wherein the cap is rotatably connected to a base and is external to the float, and rotating the cap urges the collet against a neck region of the base;
rotating the cap in a first direction to squeeze the collet against the neck region; and,
adjusting the depth of the fishing float by rotating the cap in a second direction thus loosening the collet.

23. A method of manufacturing an adjustable fishing float, comprising:
providing a float top, a float bottom, a cap containing a collet, wherein the cap is rotatably connected to a base and is external to the float top and the float bottom, and rotating the cap urges the collet against a neck region of the base;
inserting the base through an opening of the float top; and,
joining the float top and the float bottom.
